(19) United States
(12) Patent Application Publication
(10) Pub. No.: US 2020/0163175 A1
(43) Pub. Date: May 21, 2020

(54) MICROWAVE HEATING DEVICE

(71) Applicant: Industrial Technology Research Institute, Hsinchu (TW)

(72) Inventors: Chia-Ching HUANG, Changhua County (TW); Yueh-Lin TSAI, Yunlin County (TW); Ping-Hsun WU, Taoyuan City (TW); Jui-Hung CHEN, Yilan County (TW)

(21) Appl. No.: 16/234,338

(22) Filed: Dec. 27, 2018

(30) Foreign Application Priority Data
Nov. 19, 2018 (TW) 107140966

(51) Int. Cl. H05B 6/72; H05B 6/64

(52) U.S. Cl. CPC H05B 6/72; H05B 6/6408

(57) ABSTRACT

A microwave heating device is configured to heat an object. The microwave heating device includes a heating chamber, a first frequency selective plate, a second frequency selective plate, a first microwave source, and a second microwave source. The first frequency selective plate is disposed in the heating chamber. The second frequency selective plate is disposed in the heating chamber. A microwave heating space is formed between the first frequency selective plate and the second frequency selective plate. The first microwave source is disposed outside of the microwave heating space, and configured to emit a first microwave toward the first frequency selective plate. The second microwave source is disposed outside of the microwave heating space, and configured to emit a second microwave toward the second frequency selective plate.

### CROSS-REFERENCE TO RELATED APPLICATIONS

This Application claims priority of Taiwan Patent Application No. 107140966 filed on Nov. 19, 2018, the entirety of which is incorporated by reference herein.

### BACKGROUND OF THE INVENTION

### Field of the Invention

The present disclosure relates to a heating device, and in particular to a microwave heating device.

### Description of the Related Art

Taking semiconductors as an example, in the semiconductor heating process, increasing the yield of the semiconductor process requires uniform heating of a wafer. Therefore, in the prior art, the heating device can use microwaves to heat the wafer, or any other object that needs to be heated.

As shown in FIG. 1, the heating device A1 includes a heating chamber A10, a carrier A20, and a microwave source A30. The carrier A20 is put in the heating chamber A10, and configured to support the object W1, such as a wafer. Moreover, the microwave source A30 is disposed on the heating chamber A10, and configured to emit microwaves to the upper surface of the object W1.

However, existing heating devices have been generally adequate for their intended purposes, and they have not been entirely satisfactory in all respects. Consequently, it would be desirable to provide a solution for improving the heating devices.

### BRIEF SUMMARY OF THE INVENTION

The present disclosure embodiment provides a microwave heating device. The microwave heating device includes a heating chamber, a first frequency-selective plate, a second frequency-selective plate, a first microwave source, and a second microwave source. The first frequency-selective plate is disposed in the heating chamber. The second frequency-selective plate is disposed in the heating chamber. A microwave heating space is formed between the first frequency-selective plate and the second frequency-selective plate. The first microwave source is disposed outside the microwave heating space, and is configured to emit a first microwave toward the first frequency-selective plate. The second microwave source is disposed outside the microwave heating space, and configured to emit a second microwave toward the second frequency-selective plate.

In some embodiments, the first microwave enters the microwave heating space through the first frequency-selective plate to form a first selective wave. The second microwave enters the microwave heating space through the second frequency-selective plate to form a second selective wave.

In some embodiments, the first frequency-selective plate is parallel to the second frequency-selective plate. The object is put in the microwave heating space, a gas layer or a vacuum space is formed between the first frequency-selective plate and the object and between the second frequency-selective plate and the object.

In some embodiments, the microwave heating device further includes a first drive device and a second drive device. The first drive device is configured to move or rotate the first frequency-selective plate. The second drive device is configured to move or rotate the second frequency-selective plate.

In some embodiments, the object is put in the microwave heating space. In the heating process, the first drive device controls the first frequency-selective plate to move or rotate relative to the object, and the second drive device controls the second frequency-selective plate to move or rotate relative to the object.

In some embodiments, the first frequency-selective plate includes a plurality of first metal units, and the first metal units are arranged on a plane in an array. In some embodiments, each of the first metal units is a metal ring encircled into a specific shape, a metal piece with a specific contour shape or a metal piece of a specific hollow shape. The shapes and sizes of the first metal units are the same.

In some embodiments, the first frequency-selective plate includes first dielectric substrates and first metal layers. The first dielectric substrates and the first metal layers are alternately arranged in an arrangement direction. Each of the first metal layers includes first metal units that are arranged in an array.

In some embodiments, the second frequency-selective plate includes second metal units, and the second metal units are arranged on a plane in an array. In some embodiments, each of the second metal units is a metal ring encircled into a specific shape, a metal piece with a specific contour shape or a metal piece of a specific hollow shape. In some embodiments, the shapes and sizes of the second metal units are the same.

In some embodiments, the second frequency-selective plate includes second dielectric substrates and second metal layers, and the second dielectric substrates and the second metal layers are alternately arranged in an arrangement direction. Each of the second metal layers includes second metal units that are arranged in an array.

In conclusion, the microwave heating device of the present disclosure utilizes the first frequency-selective plate and the second frequency-selective plate to make the microwave generated by the first microwave source and the second microwave source to uniformly heat the object. Moreover, heating efficiency can be improved by the first frequency-selective plate and the second frequency-selective plate located at two opposite sides of the object.

### BRIEF DESCRIPTION OF THE DRAWINGS

FIG. 1 is a schematic view of a heating device.

FIG. 2 is a perspective view of the microwave heating device in accordance with an exemplary embodiment of the present disclosure.

FIG. 3 is a schematic view of the microwave heating device in accordance with an exemplary embodiment of the present disclosure.

FIG. 4 is a perspective view of the first frequency-selective plate or the second frequency-selective plate in accordance with an exemplary embodiment of the present disclosure.

FIG. 5A is a side view of the first frequency-selective plate or the second frequency-selective plate in accordance with another exemplary embodiment of the present disclosure.

FIG. 5B is a perspective view of the first frequency-selective plate or the second frequency-selective plate in accordance with another exemplary embodiment of the present disclosure.

FIG. 6A is a schematic view of the first frequency-selective plate in accordance with another exemplary embodiment of the present disclosure.

FIG. 6B is a schematic view of the first frequency-selective plate in accordance with another exemplary embodiment of the present disclosure.

FIG. 6C is a schematic view of the first frequency-selective plate in accordance with another exemplary embodiment of the present disclosure.

FIG. 6D is a schematic view of the first frequency-selective plate in accordance with another exemplary embodiment of the present disclosure.

FIG. 6E is a schematic view of the first frequency-selective plate in accordance with another exemplary embodiment of the present disclosure.

FIG. 6F is a schematic view of the first frequency-selective plate in accordance with another exemplary embodiment of the present disclosure.

FIG. 7 is a schematic view of the first metal unit in accordance with many embodiment of the present disclosure.

FIG. 8A is an electric field distribution diagram of the microwave heating device in the heating process in accordance with an exemplary embodiment of the present disclosure.

FIG. 8B is a power loss density diagram of the object of FIG. 8A in the heating process.

FIG. 9A is an electric field distribution diagram of the microwave heating device in the heating process in accordance with another exemplary embodiment of the present disclosure.

FIG. 9B is a power loss density diagram of the object of FIG. 9A in the heating process.

FIG. 10A is an electric field distribution diagram of the microwave heating device in the heating process in accordance with another exemplary embodiment of the present disclosure.

FIG. 10B is a power loss density diagram of the object of FIG. 10A in the heating process.

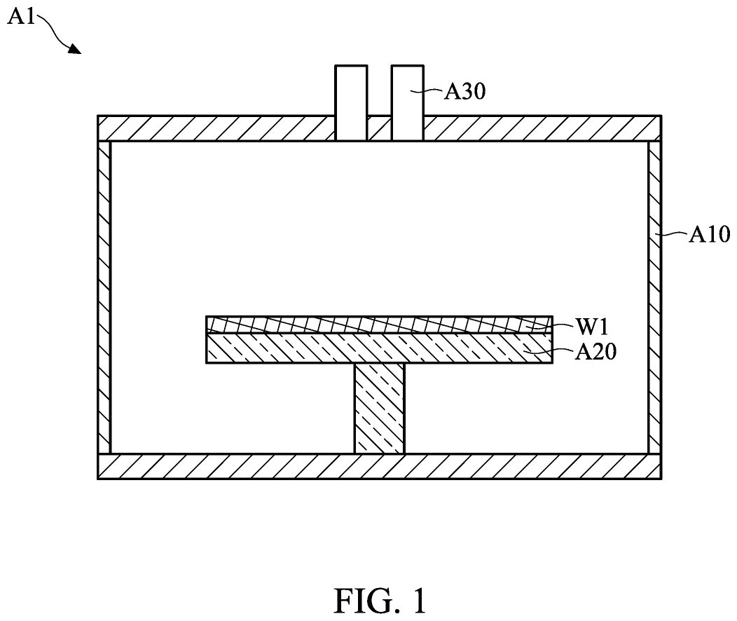

### DETAILED DESCRIPTION OF THE INVENTION

The following disclosure provides many different embodiments, or examples, for implementing different features of the present disclosure. Specific examples of components and arrangements are described below to simplify the present disclosure. For example, the formation of a first feature over or on a second feature in the description that follows may include exemplary embodiments in which the first and second features are formed in direct contact, and may also include exemplary embodiments in which additional features may be formed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed.

The words, such as “first” or “second”, in the specification are for the purpose of clarity of description only, and are not relative to the claims or meant to limit the scope of the claims. In addition, terms such as “first element” and “second element” do not indicate the same or different elements.

Spatially relative terms, such as upper and lower, may be used herein for ease of description to describe one element or feature's relationship to other elements or features as illustrated in the figures. The spatially relative terms are intended to encompass different orientations of the device in use or operation in addition to the orientation depicted in the figures. Moreover, the shape, size, and thickness depicted in the drawings may not be drawn to scale or may be simplified for clarity of discussion; these drawings are merely intended for illustration.

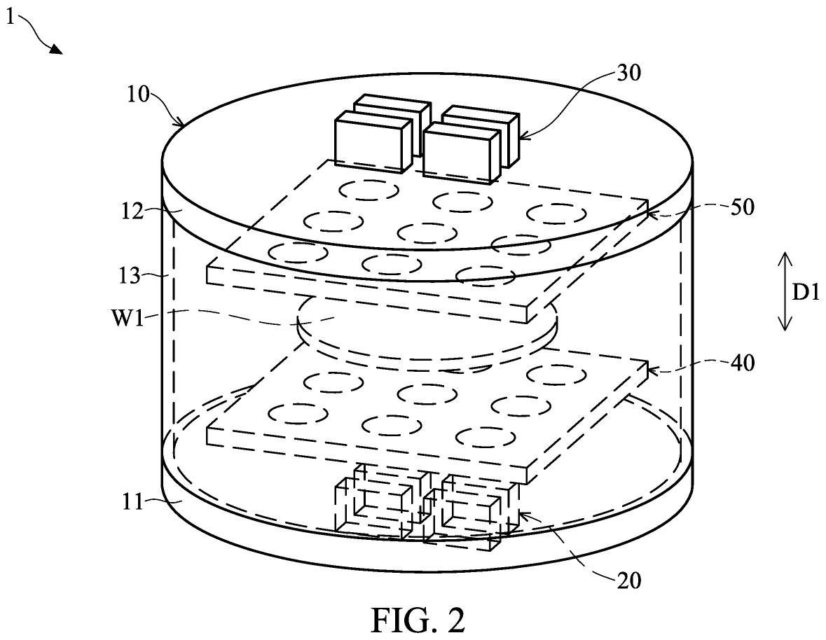

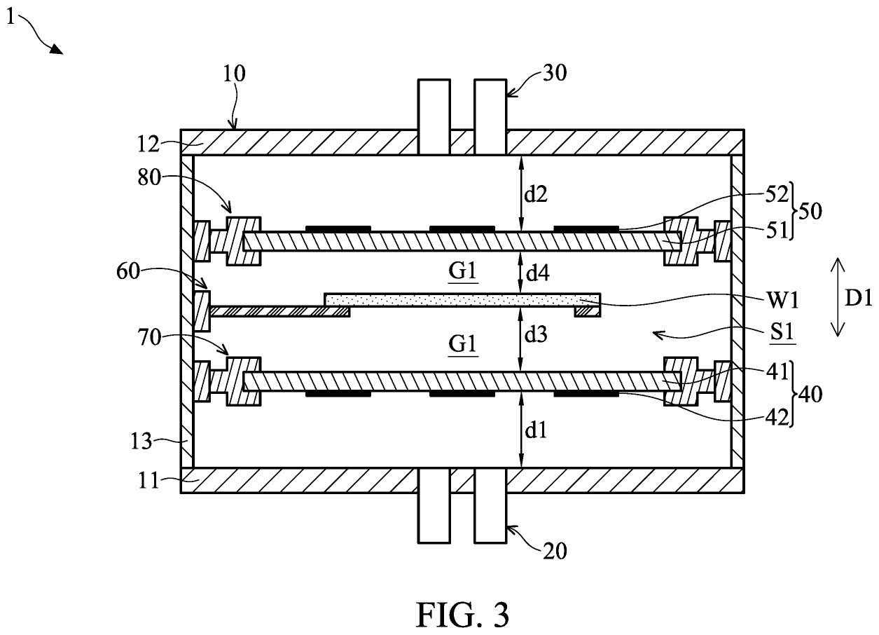

FIG. 2 is a perspective view of the microwave heating device 1 in accordance with an exemplary embodiment of the present disclosure. FIG. 3 is a schematic view of the microwave heating device 1 in accordance with an exemplary embodiment of the present disclosure. The microwave heating device 1 is configured to heat an object (workpiece) W1 by microwave. In some embodiments, the object W1 may be any object to be heated, such as food, liquid, gas, wafer, rubber, chemicals, etc., but it is not limited thereto.

The microwave heating device 1 includes a heating chamber 10, first microwave sources 20, second microwave sources 30, a first frequency-selective plate 40, and a second frequency-selective plate 50. The structure and shape of the heating chamber 10 have different designs depending on the requirements, and are not limited to FIG. 2 and FIG. 3. In one exemplary embodiment of the present disclosure, a microwave heating space S1 is formed between the first frequency-selective plate 40 and the second frequency-selective plate 50. The object W1 is put in the microwave heating space S1.

For example, the heating chamber 10 includes a bottom plate 11, a top plate 12, and a side wall 13. In the exemplary embodiment of FIG. 2, the bottom plate 11 and the top plate 12 are circular, but it is not limited thereto. The bottom plate 11 is parallel or substantially parallel to the top plate 12. In other words, the bottom plate 11 and the top plate 12 are parallel to an arrangement direction D1.

The side wall 13 is connected to the bottom plate 11 and the top plate 12, and located between the bottom plate 11 and the top plate 12. The side wall 13 extends perpendicular to the bottom plate 11 and the top plate 12. In other words, the side wall 13 may extend in the arrangement direction D1. In one exemplary embodiment, the side wall 13 may be a ring-like structure, and connected to edges of the bottom plate 11 and the top plate 12.

The first microwave sources 20 are disposed outside the microwave heating space S1. In the exemplary embodiment, the first microwave sources 20 are disposed on the heating chamber 10, and configured to emit the first microwave into the heating chamber 10. In the exemplary embodiment, the first microwave sources 20 may emit first microwave toward the first frequency-selective plate 40. The first microwave enters microwave heating space S1 through the first frequency-selective plate 40 to form a first selective wave. The first microwave sources 20 may be arranged on the bottom plate 11 in an array. In the exemplary embodiment, the first microwave sources 20 are connected to the bottom plate 11, and pass through the bottom plate 11 into the heating chamber 10. In another exemplary embodiment, the first microwave sources 20 are located in the heating chamber 10.

The first microwave sources 20 may be located at the central area of the bottom plate 11, and may be not located at the edge area of the bottom plate 11. In another exemplary embodiment, the first microwave sources 20 are uniformly distributed on the bottom plate 11. The microwave heating device includes one or more first microwave sources 20. In one exemplary embodiment, the microwave heating device 1 includes four first microwave sources 20, but it is not limited thereto.

The second microwave sources 30 are disposed outside the microwave heating space S1. In one embodiment, the second microwave sources 30 are disposed on the heating chamber 10, and configured to emit second microwave into the heating chamber 10. In the exemplary embodiment, the second microwave sources 30 may emit the second microwave toward the second frequency-selective plate 50. The second microwave enters the microwave heating space S1 through the second frequency-selective plate 50 to form a second selective wave. The second microwave sources 30 may be arranged on the top plate 12 in an array. In one exemplary embodiment, the first microwave sources 20 and the second microwave sources 30 are located at two opposite sides of the heating chamber 10.

In the arrangement direction D1, each of the first microwave sources 20 corresponds to one of the second microwave sources 30. In the exemplary embodiment, second microwave sources 30 are connected to the top plate 12, and pass through the top plate 12 into the heating chamber 10. In another exemplary embodiment, the second microwave sources 30 are located in the heating chamber 10.

The second microwave source 30 may be located at the central area of the top plate 12, and may not be located at the edge area of the top plate 12. In another exemplary embodiment, the second microwave sources 30 are uniformly distributed on the top plate 12. The microwave heating device 1 includes one or more second microwave sources 30, and the number of second microwave sources 30 may correspond to the number of first microwave sources 20. In one exemplary embodiment, the microwave heating device 1 includes four second microwave sources 30, but it is not limited thereto.

The first frequency-selective plate 40 is disposed in the heating chamber 10. The first frequency-selective plate 40 may be located over the first microwave source 20, and separated from the first microwave source 20. The first frequency-selective plate 40 may extend perpendicular or substantially perpendicular to the arrangement direction D1. Moreover, the area of the first frequency-selective plate 40 is greater than the area of the object W1.

The second frequency-selective plate 50 is disposed in the heating chamber 10, and corresponds to the first frequency-selective plate 40. The second frequency-selective plate 50 may be located under the second microwave source 30, and separated from the second microwave source 30. The second frequency-selective plate 50 may extend perpendicular to or substantially perpendicular to the arrangement direction D1. Moreover, the area of the second frequency-selective plate 40 is greater than the area of the object W1.

In one exemplary embodiment, the distance d1 between the first frequency-selective plate 40 and the first microwave source 20 may be equal to the distance d2 of the second frequency-selective plate 50 and the second microwave source 30. The distance d1 and the distance d2 may be measured in the arrangement direction D1.

In one exemplary embodiment, the size, shape, structure and/or material of the first frequency-selective plate 40 may be the same as the second frequency-selective plate 50. The first frequency-selective plate 40 is separated from and parallel to the second frequency-selective plate 50. In the exemplary embodiment, the first microwave source 20, the first frequency-selective plate 40, the second frequency-selective plate 50, and the second microwave source 30 are arranged in the arrangement direction D1.

During the heating process, the object W1 may be put between the first frequency-selective plate 40 and the second frequency-selective plate 50. In one exemplary embodiment, the object W1 or the packaging structure thereof may be a plate structure, but it is not limited thereto, and may be parallel to the first frequency-selective plate 40 and the second frequency-selective plate 50.

The first frequency-selective plate 40 is separated from the object W1, and an interval area G1 is formed between the first frequency-selective plate 40 and the object W1. The second frequency-selective plate 50 is separated from the object W1, and the interval area G1 is formed between the second frequency-selective plate 50 and the object W1. The interval area G1 may be a gas layer or vacuum space. In one exemplary embodiment, the distance d3 between the first frequency-selective plate 40 and the object W1 may be equal to the distance d4 from the second frequency-selective plate 50 to the object W1. The distance d3 and the distance d4 may be measured in the arrangement direction D1.

The distance d3 between the first frequency-selective plate 40 and the object W1 may correspond to the wavelength of the first microwave. In one exemplary embodiment, the distance d3 may be one wavelength, half wavelength, or quarter wavelength of the first microwave. The distance d4 of the second frequency-selective plate 50 and the object W1 may correspond to the wavelength of the second microwave. In one exemplary embodiment, the distance d4 may be one wavelength, half wavelength, or quarter wavelength of the second microwave.

The first microwave source 20 emits the first microwave toward the first frequency-selective plate 40. The first frequency-selective plate 40 is configured to filter the first microwave. The first frequency-selective plate 40 allows the first microwave in a first frequency range to pass, and blocks the first microwave out to the first frequency range. The first microwave passing through the first frequency-selective plate 40 forms a first selective wave.

The second microwave source 30 may emit the second microwave toward the second frequency-selective plate 50. The second frequency-selective plate 50 is configured to filter the second microwave. The second frequency-selective plate 50 allows the second microwave in the second frequency range to pass, and blocks the first microwave from the second frequency range. The second microwave passing through the second frequency-selective plate 50 forms a second selective wave.

In one exemplary embodiment, the first frequency range may be the same as the second frequency range. In another exemplary embodiment, the first frequency range may not be equal to the second frequency range. For example, the first frequency range may be in a range from 300 MHz to 300 GHz. The second frequency range may be in a range from 300 MHz to 300 GHz.

The first selective wave and the second selective wave may form a resonance in the heating chamber, and to the object W1. The object W1 may be heated by absorbing the first selective wave and the second selective wave.

In one exemplary embodiment, the microwave heating device 1 further includes a transmission device 60, a first drive device 70 and a second drive device 80. The transmission device 60 is configured to support and transfer the object W1. The transmission device 60 may contact with the edge of the object W1, and may not directly contact the central area of the object W1. Before the heating process, the transmission device 60 transfers the object W1 to be heated into the heating chamber 10. In the heating process, the transmission device 60 maintains the object W1 located between the first frequency-selective plate 40 and the second frequency-selective plate 50. After the heating process, the transmission device 60 removed the heated object W1 from the heating chamber 10.

The first drive device 70 is configured to move or rotate the first frequency-selective plate 40, and the second drive device 80 is configured to move or rotate the second frequency-selective plate 50. For example, in one heating process, the first drive device 70 may control the first frequency-selective plate 40 to continuously or intermittently move relative to the object W1. The second drive device 80 may control the second frequency-selective plate 50 to continuously or intermittently move relative to the object W1. The object W1 may be uniformly heated by changing the distance d3 between the first frequency-selective plate 40 and the object W1. Moreover, the object W1 may be uniformly heated by changing the distance d4 between the second frequency-selective plate 50 and the object W1.

For example, in one heating process, the first drive device 70 may control the first frequency-selective plate 40 to continuously or intermittently rotate relative to the object W1, and the second drive device 80 controls the second frequency-selective plate 50 to continuously or intermittently rotate relative to the object W1. The object W1 may be uniformly heated by changing the orientation between the first frequency-selective plate 40 and the object W1. Moreover, the object W1 may be uniformly heated by changing the orientation between the second frequency-selective plate 50 and the object W1.

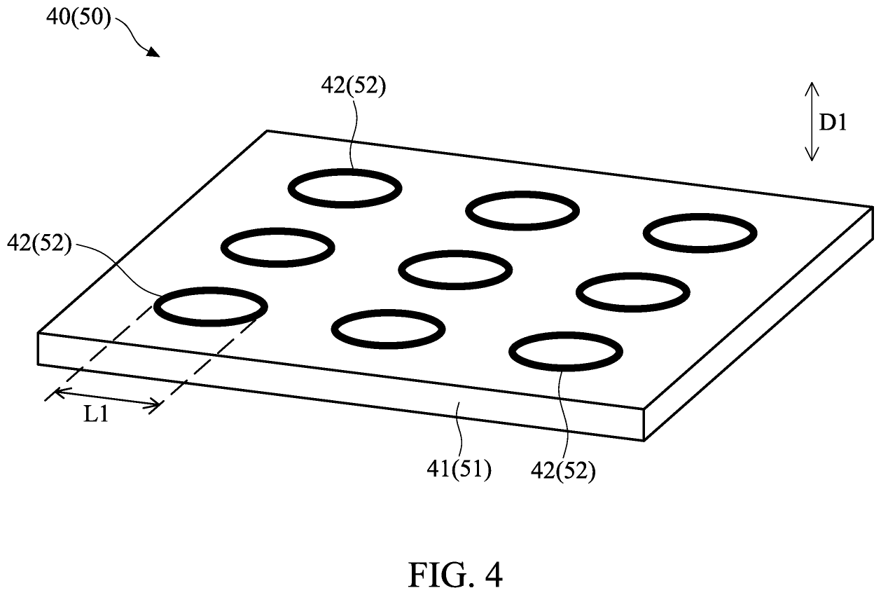

FIG. 4 is a perspective view of the first frequency-selective plate 40 or the second frequency-selective plate 50 in accordance with an exemplary embodiment of the present disclosure. As shown in FIG. 4, the first frequency-selective plate 40 includes a first dielectric substrate 41 and first metal units 42. The first dielectric substrate 41 may extend perpendicular to the arrangement direction D1. The first dielectric substrate 41 may be a non-metallic substrate, such as a glass substrate or a tantalum substrate. The first metal units 42 may be arranged on a plane in an array, and formed as a frequency-selective surface. In the exemplary embodiment, the first metal units 42 may be arranged on the first dielectric substrate 41 in an array. For example, the first metal units 42 include copper or iron.

Each first metal unit 42 may be in form of a through hole or solid. In some exemplary embodiments, each the first metal unit 42 may be a metal ring with a specific shape, a metal piece with a specific contour shape or a metal piece with a specific puncture pattern. In the exemplary embodiment, the first metal unit 42 may be a circular metal ring. The shapes and sizes of the first metal units 42 may be the same. In another exemplary embodiment, the shapes and sizes of the first metal units 42 may be different. In another exemplary embodiment, the first metal units 42 may be disposed on two opposite sides of the first dielectric substrate 41. Moreover, each of the first metal units 42 corresponds to one of the first metal units 42 on the opposite side of the first dielectric substrate 41 in the arrangement direction D1.

The size of the first metal unit 42 may correspond to the size of wavelength of the first microwave. In one exemplary embodiment, the greatest length L1 of the first metal unit 42 is less than one wavelength, half wavelength, or one quarter wavelength of the first microwave. The length L1 may be measured in a direction perpendicular to the arrangement direction D1.

As shown in FIG. 4, the second frequency-selective plate 50 includes a second dielectric substrate 51 and second metal units 52. The second dielectric substrate 51 may extend perpendicular to the arrangement direction D1. The second dielectric substrate 51 may be a non-metallic substrate, such as a glass substrate or a silicon substrate. The second metal units 52 may be arranged on a plane in an array, and forms a frequency-selective surface. In one exemplary embodiment, the second metal units 52 may be arranged on the second dielectric substrate 51 in an array. For example, the second metal unit 52 may include copper or iron.

Each second metal unit 52 may be in form of through hole, or solid. In some exemplary embodiments, each the second metal unit 52 may be a metal ring in a specific shape, a metal piece with a specific contour shape or a metal piece with a puncture pattern. In the exemplary embodiment, the second metal unit 52 may be a circular metal ring. The shapes and sizes of the second metal units 52 may be the same. In another exemplary embodiment, the shapes and sizes of the second metal units 52 may be different. In another exemplary embodiment, the shapes and/or the sizes of the second metal units 52 may be different from the shapes and/or the sizes of the first metal units 42.

The size of the second metal unit 52 may correspond to the size of the wavelength of the second microwave. In the exemplary embodiment, the greatest length L1 of the second metal unit 52 is less than one wavelength, half wavelength, or one quarter wavelength of the second microwave. The length L1 may be measured in a direction perpendicular to the arrangement direction D1.

In some embodiments, the second metal unit 52 may be disposed on two opposite sides of the second dielectric substrate 51. Moreover, each of the second metal units 52 corresponds to one of the second metal units 52 on the opposite side of the second dielectric substrate 51 in the arrangement direction D1.

In the heating process, each of the first metal units 42 may form a resonator that may uniformly radiating the first selective wave. Each of the second metal unit 52 may form a resonator that may uniformly radiate the second selective wave. Therefore, the microwave heating device 1 of the present disclosure can uniformly heat the object W1.

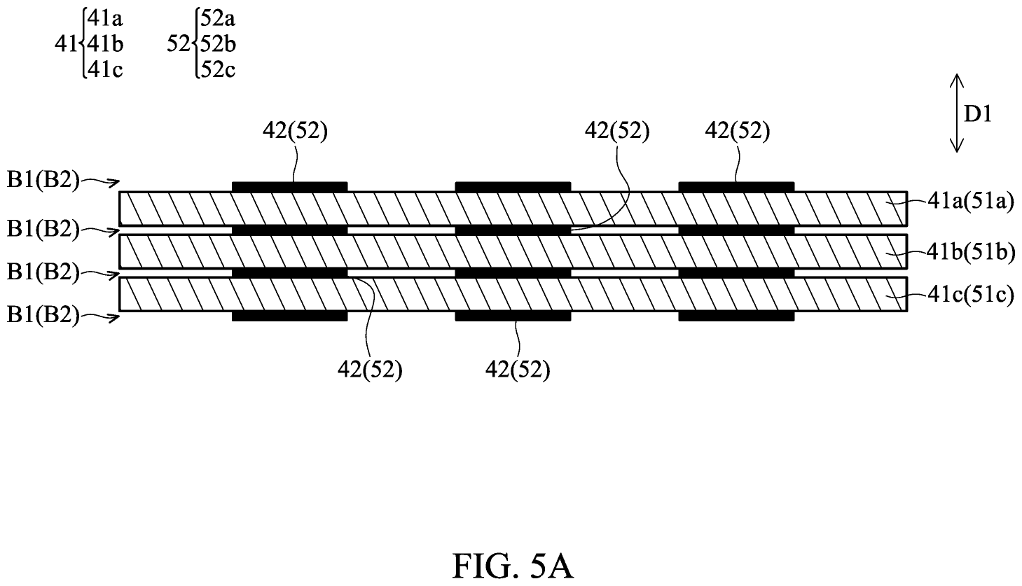

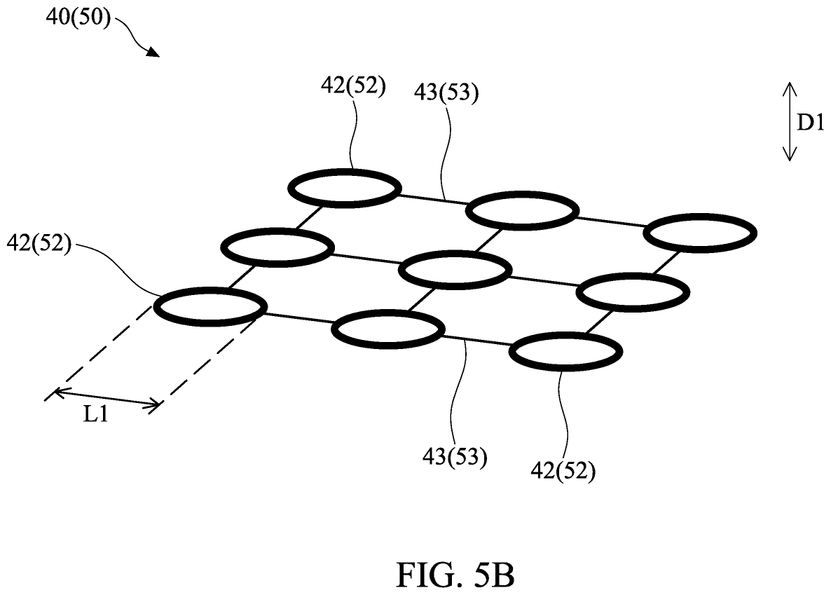

FIG. 5A is a side view of the first frequency-selective plate 40 or the second frequency-selective plate 50 in accordance with another exemplary embodiment of the present disclosure. The first frequency-selective plate 40 may include first dielectric substrates 41 (the first dielectric substrate 41a, the first dielectric substrate 41b, and the first dielectric substrate 41c) and the first metal layers B1. Each of the first metal layers B1 includes first metal units 42 arranged in an array. The first dielectric substrates 41 and the first metal layers B1 may be alternately arranged in the arrangement direction D1, and parallel to each other. In the exemplary embodiment, the first dielectric substrates 41 and the first metal layers B1 may extend perpendicular to the arrangement direction D1.

As shown in FIG. 5A, the first metal units 42 may be disposed on the first dielectric substrate 41a, between the first dielectric substrate 41a and the first dielectric substrate 41b, between the first dielectric substrate 41b and the first dielectric substrate 41c, and under the first dielectric substrate 41c. In one exemplary embodiment, the shapes and sizes of the first metal units 42 in one of the first metal layers B1 may be different from the shapes and sizes of the first metal units 42 in another one of the first metal layers B1.

The second frequency-selective plate 50 may include second dielectric substrates 51 (the second dielectric substrate 51a, the second dielectric substrate 51b, and the second dielectric substrate 51c) and second metal layers B2. Each of the second metal layers B2 includes second metal units 52 that are arranged in an array. The second dielectric substrates 51 and the second metal layers B2 may be alternately arranged in the arrangement direction D1, and may be parallel to each other. In the exemplary embodiment, the second dielectric substrates 51 and the second metal layers B2 may extend perpendicular to the arrangement direction D1.

As shown in FIG. 5A, the second metal units 52 are disposed on the second dielectric substrates 51a, between the second dielectric substrate 51a and the second dielectric substrate 51b, between the second dielectric substrate 51b and the second dielectric substrate 51c, and under the second dielectric substrate 51c. In one exemplary embodiment, the shapes and sizes of the second metal units 52 in one of the second metal units 52 may be different from the shapes and sizes of the second metal units 52 in another one of the second metal unit 52.

FIG. 5B is a perspective view of the first frequency-selective plate 40 or the second frequency-selective plate 50 in accordance with another exemplary embodiment of the present disclosure. In one exemplary embodiment, the first frequency-selective plate 40 may not include a first dielectric substrate 41. The first frequency-selective plate 40 further includes connection lines 43 connected to two adjacent first metal units 42. The connection line 43 and the first metal unit 42 are arranged on a plane. The connection line 43 may include insulating materials or metal materials.

In the exemplary embodiment, the second frequency-selective plate 50 may not include a first dielectric substrate 51. The first frequency-selective plate 50 further includes connection lines 53 connected to two adjacent first metal units 52. The connection line 53 and the first metal unit 52 may be arranged on a plane. The connection line 53 may include insulating materials or metal materials.

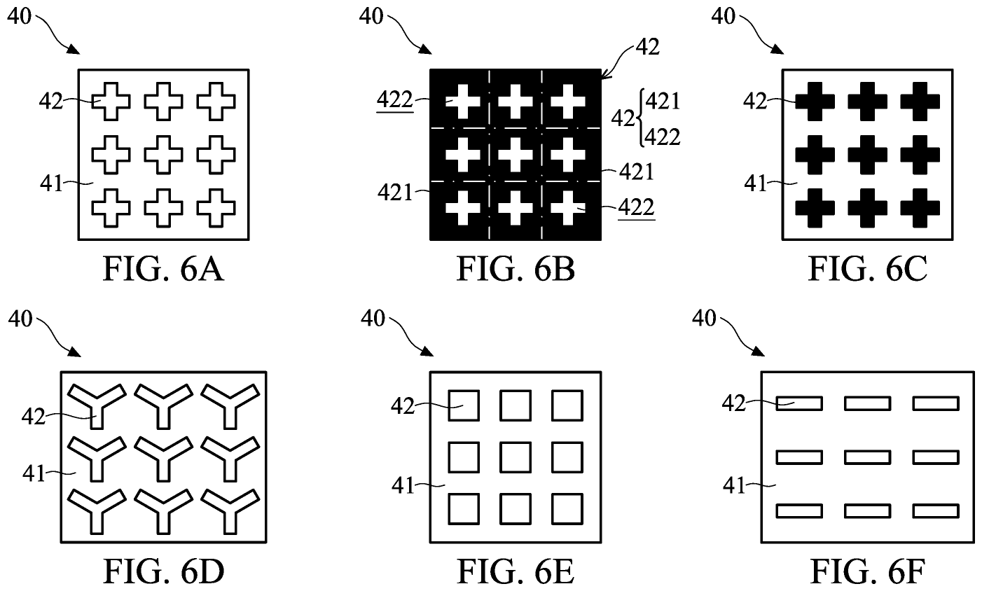

FIG. 6A is a schematic view of the first frequency-selective plate 40 in accordance with another exemplary embodiment of the present disclosure. In FIG. 6A, the first metal unit 42 is a metal ring with a cross shape. FIG. 6B is a schematic view of the first frequency-selective plate 40 in accordance with another exemplary embodiment of the present disclosure. The first metal unit 42 may be a metal piece with a cross-shaped through hole. The first metal unit 42 may include a metal layer 421 extending along a plane and a through hole 422 penetrating through the metal layer 421. FIG. 6C is a schematic view of the first frequency-selective plate 40 in accordance with another exemplary embodiment of the present disclosure. In the exemplary embodiment, the first metal unit 42 may be a cross-shaped metal piece.

FIG. 6D is a schematic view of the first frequency-selective plate 40 in accordance with another exemplary embodiment of the present disclosure. In FIG. 6D, the first metal unit 42 may be a metal ring in a Y shape. In some exemplary embodiments, the first metal unit 42 may be a metal piece with a Y-shaped through hole or a Y-shaped metal piece.

FIG. 6E is a schematic view of the first frequency-selective plate 40 in accordance with another exemplary embodiment of the present disclosure. In FIG. 6E, the first metal unit 42 may be a metal ring in a square shape. In some exemplary embodiments, the first metal unit 42 may be a metal piece with a square-shaped through holes or a square-shaped metal piece.

FIG. 6F is a schematic view of the first frequency-selective plate 40 in accordance with another exemplary embodiment of the present disclosure. In FIG. 6F, the first metal unit 42 may be a metal ring in an elongated shape. In some exemplary embodiments, the first metal unit 42 may be a metal piece with an elongated through hole or an elongated metal piece.

The second frequency-selective plate 50 of the present disclosure may have the same structure, shape, and/or size as the first frequency-selective plate 40. The second metal unit 52 may be designed according to the first metal unit 42 described above.

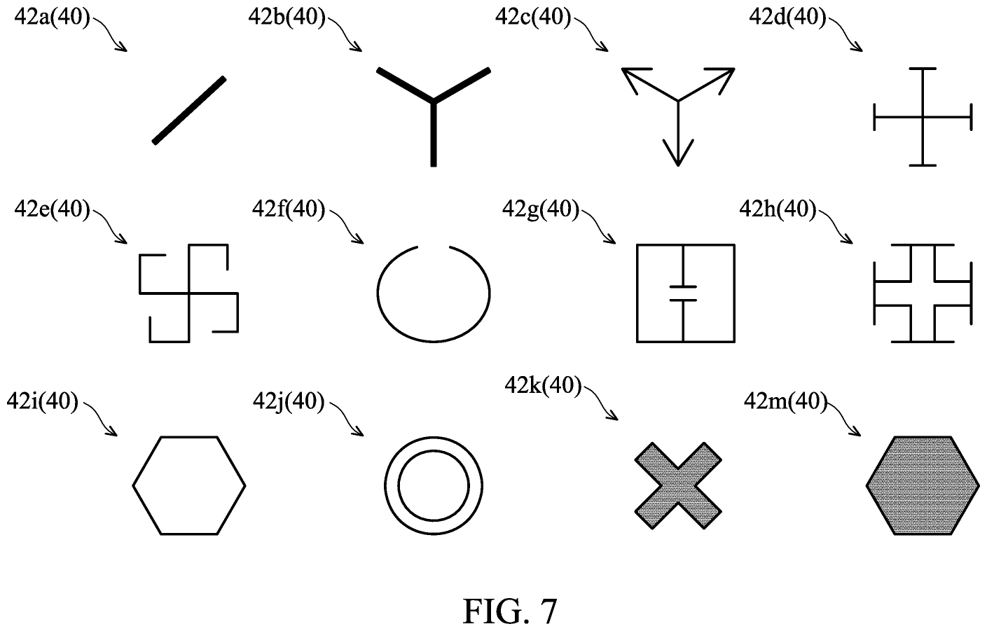

FIG. 7 is a schematic view of the first metal unit 42 in accordance with many exemplary embodiments of the present disclosure. The first metal units 42a, 42b, 42c, 42d, 42e, 42f and 42g may be in line shape. The first metal unit 42a may be a lineally extending line. The first metal unit 42b may be lines in radial arrangement. In the exemplary embodiment, the first metal unit 42b may be lines arranged into Y-shape. In the exemplary embodiment, the central area of the first metal unit 42g forms a capacitor with the function of capacitance.

The first metal unit 42i may be a through hole in a polygon shape. In the exemplary embodiment, the first metal unit 42i may be a through hole in hexagonal shape. In another exemplary embodiment, the first metal unit 42i may be a through hole in shape above triangle. The first metal unit 42j may be rings of concentric circles.

The first metal unit 42k may be solid piece in a cross-shaped, and the orientation of the first metal unit 42k may be different from the orientation of the first metal unit 42 of FIG. 6A. The first metal unit 42m may be a solid piece in polygons. In the exemplary embodiment, the first metal unit 42m may be a solid piece in hexagons. In some exemplary embodiments, the first metal unit 42m may be a solid piece in shape of triangle or more.

The second metal unit 52 of the present disclosure may have the same structure, shape, and/or size as the first metal unit 42. The second metal unit 52 may be designed according to the first metal unit 42 described above.

The disclosed features may be combined, modified, or replaced in any suitable manner in one or more disclosed embodiments, but are not limited to any particular embodiments.

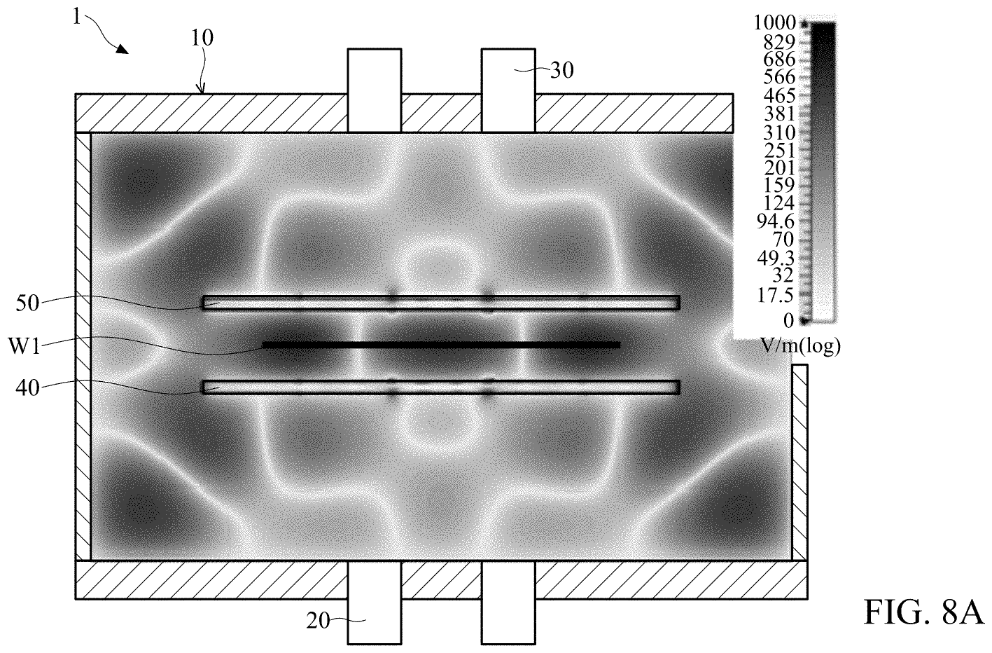

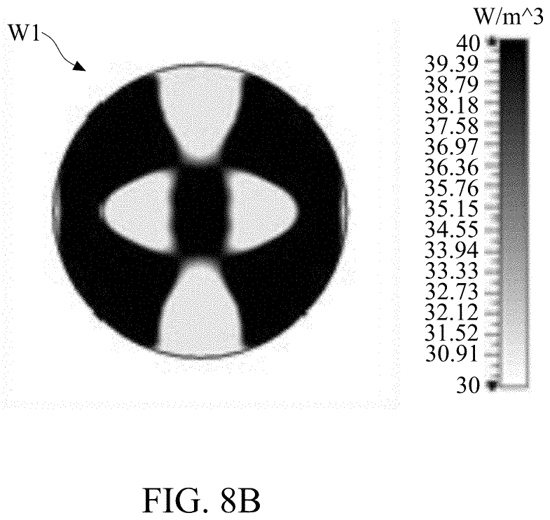

FIG. 8A is an electric field distribution diagram of the microwave heating device 1 in the heating process in accordance with an exemplary embodiment of the present disclosure. FIG. 8B is a power loss density diagram of the object W1 of FIG. 8A in the heating process. In the exemplary embodiment, the distance d3 between the first frequency-selective plate 40 and the object W1 is equal to one quarter wavelength of the first microwave. The distance d4 between the second frequency-selective plate 50 and the object W1 is equal to one quarter wavelength of the second microwave. Moreover, the distance d3 may be equal to the distance d4.

As shown FIG. 8A, the electric field between the first frequency-selective plate 40 and the second frequency-selective plate 50 is uniformly distributed on the surface of the object W1. When the electric field is more uniformly distributed, the surface of W1 represents that the object W1 can be heated more uniformly.

As shown in FIG. 8B, the higher the power loss density power loss density on the surface of the object W1, the higher the energy absorbed by the object W1, and the more heat is added. The power loss density of the surface of the object W1 is uniform. Therefore, the object W1 of the exemplary embodiment can be heated uniformly.

In the embodiment, the average power provided by each first microwave source 20 and second microwave source 30 is 0.5 W. The frequency of the first microwave and the second microwave is about 2.45 GHz, and the wavelength of the first microwave and the second microwave can be about 12.2 cm. The area of the object W1 having a power loss density of greater than 0 W/m\hat{ }3 accounts for 100% of the volume of the object W1. The area of the object W1 having a power loss density of greater than 20 W/m\hat{ }3 accounts for 82.79% of the volume of the object W1. The area of the object W1 having a power loss density of greater than 40 W/m\hat{ }3 accounts for 60.31% of the volume of the object W1. The area of the object W1 having a power loss density of greater than 100 W/m\hat{ }3 accounts for 14.22% of the volume of the object W1. Therefore, the microwave heating device 1 of the present disclosure may have good heating efficiency.

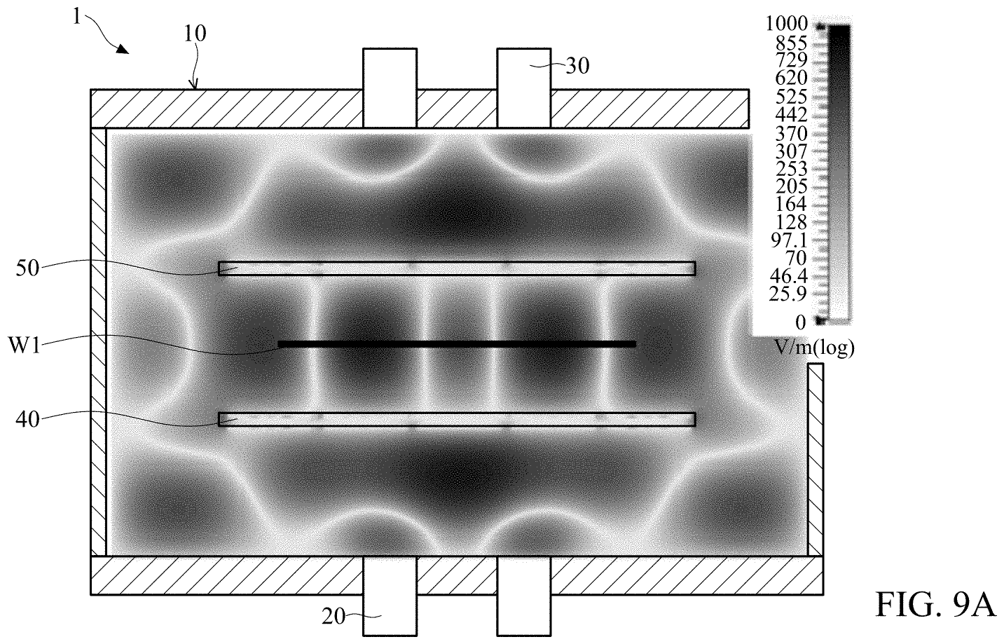

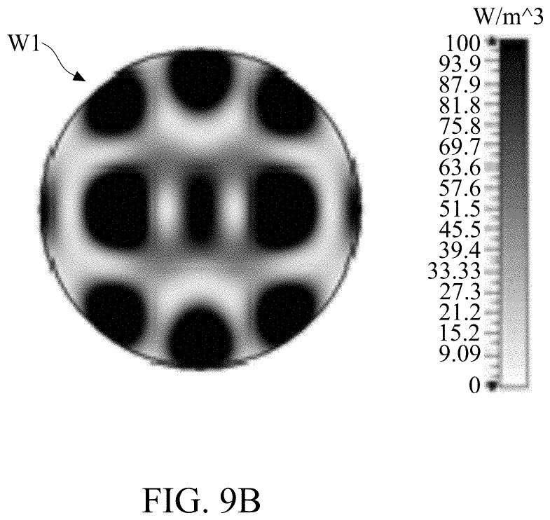

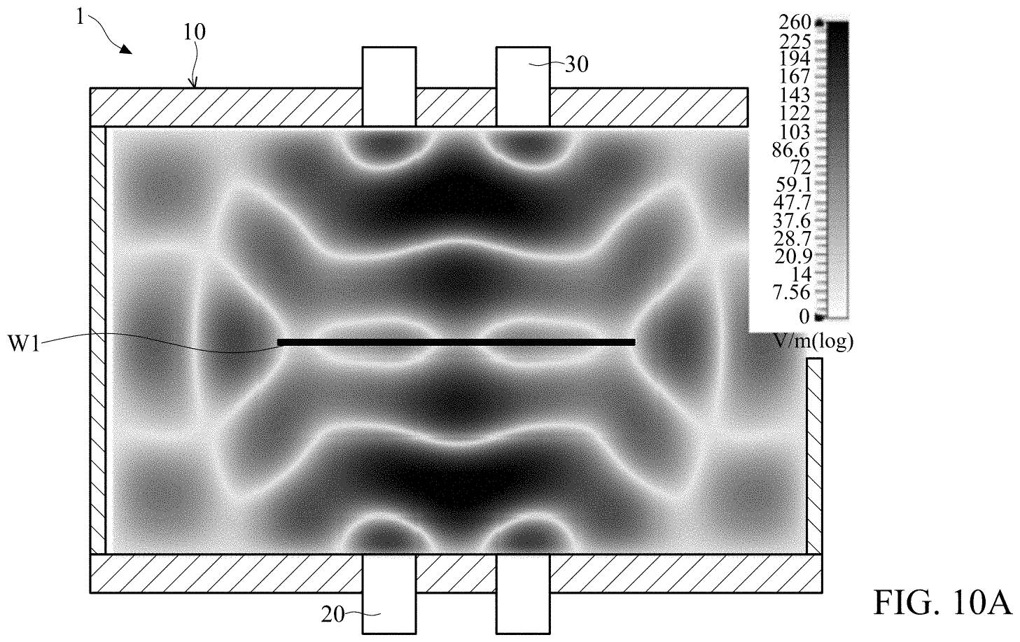

FIG. 9A is an electric field distribution diagram of the microwave heating device 1 in the heating process in accordance with another exemplary embodiment of the present disclosure. FIG. 9B is a power loss density diagram of the object W1 of FIG. 9A in the heating process. In the exemplary embodiment, the distance d3 between the first frequency-selective plate 40 and the object W1 is equal to a half wavelength of the first microwave. The distance d4 between the second frequency-selective plate 50 and the object W1 is equal to a half of the wavelength of the second microwave. Moreover, the distance d3 may be equal to the distance d4.

As shown FIG. 9A, the electric field between the first frequency-selective plate 40 and the second frequency-selective plate 50 is uniformly distributed on the surface of the object W1. As shown in FIG. 9B, the power loss density of the surface of the object W1 is uniform. Therefore, the object W1 of the exemplary embodiment can be heated uniformly.

In the exemplary embodiment, the average power provided by each first microwave source 20 and second microwave source 30 is 0.5 W. The frequency of the first microwave and the second microwave is about 2.45 GHz, and the wavelength of the first microwave and the second microwave can be about 12.2 cm. The area of the object W1 having a power loss density of greater than 0 W/m\hat{ }3 accounts for 100% of the volume of the object W1. The area of the object W1 having a power loss density of greater than 20 W/m\hat{ }3 accounts for 79.25% of the volume of the object W1. The area of the object W1 having a power loss density of greater than 40 W/m\hat{ }3 accounts for 62.79% of the volume of the object W1. The area of the object W1 having a power loss density of greater than 100 W/m\hat{ }3 accounts for 32.36% of the volume of the object W1. Therefore, the microwave heating device 1 of the present disclosure may have good heating efficiency.

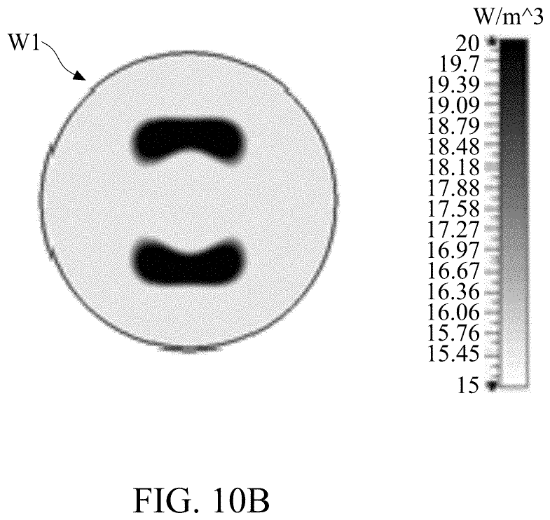

FIG. 10A is an electric field distribution diagram of the microwave heating device 1 in the heating process in accordance with another exemplary embodiment of the present disclosure. FIG. 10B is a power loss density diagram of the object W1 of FIG. 10A in the heating process. In the exemplary embodiment, the microwave heating device 1 does not include the first frequency-selective plate 40 and the second frequency-selective plate 50. The first microwave source 20 directly generates first microwave to the object W1, and the second microwave source 30 directly generates second microwave to the object W1.

As shown in FIG. 10A, the electric field is weaker on the surface of object W1. As shown in FIG. 10B, the surface of the object W1 has a lower power loss density. Therefore, if the microwave heating device 1 does not include the first frequency-selective plate 40 and/or the second frequency-selective plate 50, the uniformity of heating the object W1 is reduced.

In the exemplary embodiment, the average power provided by each first microwave source 20 and second microwave source 30 is 0.5 W. The frequency of the first microwave and the second microwave is about 2.45 GHz, and the wavelength of the first microwave and the second microwave can be about 12.2 cm. The area of the object W1 having a power loss density of greater than 20 W/m\hat{ }3 accounts for 7.92% of the volume of the object W1. The area of the object W1 having a power loss density of greater than 40 W/m\hat{ }3 accounts for 0% of the volume of the object W1. The area of the object W1 having a power loss density of greater than 100 W/m\hat{ }3 accounts for 0% of the volume of the object W1. Therefore, if the microwave heating device 1 does not include the first frequency-selective plate 40 and/or the second frequency-selective plate 50, the heating efficiency of the microwave heating device 1 is reduced.

In conclusion, the microwave heating device of the present disclosure utilizes the first frequency-selective plate and the second frequency-selective plate to make the microwave generated by the first microwave source and the second microwave source to uniformly heat the object. Moreover, heating efficiency can be improved by the first frequency-selective plate and the second frequency-selective plate located at two opposite sides of the object.

While the present disclosure has been described by way of example and in terms of preferred embodiment, it should be understood that the present disclosure is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A microwave heating device, comprising:
a heating chamber;
a first frequency-selective plate disposed in the heating chamber;
a second frequency-selective plate disposed in the heating chamber, and separated from the first frequency-selective plate, wherein a microwave heating space is formed between the first frequency-selective plate and the second frequency-selective plate;
a first microwave source disposed outside the microwave heating space, and configured to emit a first microwave to the first frequency-selective plate; and
a second microwave source disposed outside the microwave heating space, and configured to emit a second microwave to the second frequency-selective plate.

2. The microwave heating device as claimed in claim 1, wherein the first microwave enters the microwave heating space through the first frequency-selective plate to form a first selective wave, and the second microwave enters the microwave heating space through the second frequency-selective plate to form a second selective wave.

3. The microwave heating device as claimed in claim 1, wherein the first frequency-selective plate is parallel to the second frequency-selective plate.

4. The microwave heating device as claimed in claim 1, wherein an object is put in the microwave heating space, and a gas layer or a vacuum space is formed between the first frequency-selective plate and the object and between the second frequency-selective plate and the object.

5. The microwave heating device as claimed in claim 1, further comprising:
a first drive device configured to move or rotate the first frequency-selective plate; and
a second drive device configured to move or rotate the second frequency-selective plate.

6. The microwave heating device as claimed in claim 5, wherein the object is put in the microwave heating space, wherein in a heating process, the first drive device controls the first frequency-selective plate to move or rotate relative to the object, and the second drive device controls the second frequency-selective plate to move or rotate relative to the object.

7. The microwave heating device as claimed in claim 1, wherein the first frequency-selective plate includes a plurality of first metal units, and the first metal units are arranged on a plane in an array.

8. The microwave heating device as claimed in claim 7, wherein each of the first metal units is a metal ring with a specific shape, a metal piece with a specific shape or a metal piece with a puncture pattern.

9. The microwave heating device as claimed in claim 7, wherein the shapes and sizes of the first metal units are the same.

10. The microwave heating device as claimed in claim 1, wherein the first frequency-selective plate comprises a plurality of first dielectric substrates and a plurality of first metal layers, and the first dielectric substrates and the first metal layers are alternately arranged in an arrangement direction, wherein each of the first metal layers comprises a plurality of first metal units that are arranged in an array.

11. The microwave heating device as claimed in claim 1, wherein the second frequency-selective plate comprises a plurality of second metal units, and the second metal units are arranged on a plane in an array.

12. The microwave heating device as claimed in claim 11, wherein each of the second metal units is a metal ring in a specific shape, a metal piece in a specific shape or a metal piece with a puncture pattern.

13. The microwave heating device as claimed in claim 11, wherein the shapes and sizes of the second metal units are the same.

14. The microwave heating device as claimed in claim 10, wherein the second frequency-selective plate comprises a plurality of second dielectric substrates and a plurality of second metal layers, and the second dielectric substrates and the second metal layers are alternately arranged in an arrangement direction, wherein each of the second metal layers comprises a plurality of second metal units that are arranged in an array.

15. The microwave heating device as claimed in claim 4, wherein the first frequency-selective plate and the second frequency-selective plate are located at two opposite sides of the object.

16. The microwave heating device as claimed in claim 5, wherein the first drive device is configured to continuously or intermittently move or rotate the first frequency-selective plate, and the second drive device continuously or intermittently moves or rotates the second frequency-selective plate.
